(19) United States
(12) Patent Application Publication
(10) Pub. No.: US 2020/0298456 A1
(43) Pub. Date: Sep. 24, 2020

(54) Device and method for machining a plate-shaped workpiece for a motor vehicle

(71) Applicant: WEBASTO SE, Stockdolf (DE)

(72) Inventors: Martin Seebaß, Stockdorf (DE); Claus Thomas, Hohenhameln-Mehrum (DE); Heiko Hattendorf, Lehrte (DE)

(21) Appl. No.: 16/087,820

(22) PCT Filed: Mar. 23, 2017
(86) PCT No.: PCT/EP2017/056948

§ 371 Date: Sep. 24, 2018

(30) Foreign Application Priority Data
Mar. 31, 2016 (DE) 10 2016 105 900.5

(51) Int. Cl. B29C 45/14; B29C 45/26

(52) U.S. Cl. CPC B29C 45/14065; B29L 2007/002; B29C 45/26; B29C 45/14336

(57) ABSTRACT

A device for machining a plate-shaped workpiece for a motor vehicle comprises a lower tool with a holding region for the workpiece, and a folding element which has a holding region for the workpiece and which is movable relative to the lower tool. The folding element (40) can change from a first state into a second state and can thereby form a first cavity between the holding region of the folding element and the workpiece.

Methods for machining a plate-shaped workpiece require special tools which make the desired machining operation possible. For example, when producing and attaching a foam encapsulation on windows for motor vehicles, the window which is to be machined is worked on by means of special molding tools and the foam encapsulation is formed at the edge of the window. It is thereby possible to connect components to the window and also to prepare a fastening of the window to a body of a motor vehicle.

A special forming or foaming tool necessary for this purpose generally has two tool halves which are coordinated with each other as an upper part and lower part and enable foam encapsulations to be formed. The tool halves have to be held and movable here in respective mold carriers in order to permit a desired formation of foam encapsulation. One such formation of a foam encapsulation is described, for example, in EP 0355209 B1.

It is an object on which the invention is based to provide a device and a method for machining a plate-shaped workpiece for a motor vehicle, which device and method are suitable for permitting a time-saving and cost-effective construction of a vehicle roof.

The object is achieved by the features of the independent patent claims.

A device according to the invention for machining a plate-shaped workpiece for a motor vehicle comprises a lower tool with a holding region for the workpiece, and a folding element which has a holding region for the workpiece and which is movable relative to the lower tool. The folding element can change from a first state into a second state by means of a translatory movement relative to the lower tool and can form a first cavity between the holding region of the folding element and the workpiece. The translatory movement of the folding element predominantly takes place here in a first direction which is parallel to a main plane of extent of the plate-shaped workpiece.

If the workpiece is, for example, oriented substantially parallel to an underlying surface, it predominantly extends in a horizontal plane, and the translatory movement of the folding element for the most part takes place in said plane. For example, the folding element is brought horizontally laterally up to the workpiece in order then to form the first cavity at a predetermined position in contact with the workpiece. Reliable and secure contact is formed, for example, by means of the folding element being deposited vertically on the workpiece. Such a vertical movement relative to the workpiece and the lower tool is significantly less pronounced here than the previously described horizontal movement.

In other words, it is possible within the scope of such a translatory movement to move the folding element over a first distance along the first horizontal direction and over a second distance along a second vertical direction, wherein the first distance predominates in relation to the second. For example, the second distance corresponds to less than 50% of the first distance. In other refinements of the device, the second distance corresponds to less than 10% of the first distance.

The device can in particular have a plurality of separate folding elements which, as previously described, can be brought horizontally up to the workpiece to be machined, and therefore, for example, opposite folding elements are moved in a translatory manner toward each other until a respective predetermined position relative to the workpiece or the lower tool is reached, in order to form one or more designated cavities.

A further device according to the invention for machining a plate-shaped workpiece for a motor vehicle comprises a lower tool with a holding region for the workpiece, and a folding element which has a holding region for the workpiece and which is pivotable about a first axis. The folding element can change from a first state into a second state by means of folding over about the first axis and can form a first cavity between the holding region of the folding element and the workpiece.

According to such a device, a substantial relative movement of the folding element with respect to the workpiece or the lower tool takes place in the form of a pivoting movement about the first axis. This makes it possible to realize a space-saving device for machining a plate-shaped workpiece, without requiring substantial translatory movements of the folding element. Furthermore, however, in particular also a combination of such a device with the properties of the previously described device is possible, and therefore the folding element is designed to be movable in a translatory manner and also pivotable. Such a device includes additional degrees of freedom in the machining of the workpiece and can therefore contribute to a reliable and safe machining process.

By means of the described devices, a tool for machining a plate-shaped workpiece for a motor vehicle can be realized, which tool can contribute to cost-effective and time-saving machining of the workpiece. In particular, foam encapsulation and adhesive processes are possible by means of the described device without changing machines, and therefore, inter alia, a contribution is made to a low-outlay and cost-effective construction of a vehicle roof.

The described device makes it possible to realize both continuous and also discontinuous foam encapsulations at the edge of windows for motor vehicles. The device therefore realizes a molding tool without an upper tool, and therefore access to an upper side of the workpiece is freely accessible in order to permit simultaneously or swiftly following or preceding machining steps of the plate-shaped workpiece. In this connection, it is pointed out that terms such as “top” and “upper side” or “upper tool” and “lower tool” are based on a substantially vertical direction perpendicular to a surface of the workpiece or of an underlying surface for the device.

For example, the workpiece which is to be machined can be encapsulated with foam at an edge by means of the device and can be machined in the inner region by means of an adhesive bonding process without requiring a complicated and time-intensive changing of machines. Owing to this “open” structure of the device, additional degrees of freedom are made possible during the machining of the plate-shaped workpiece.

The plate-shaped workpiece is realized, for example, as a metal sheet or as a glass cover, side window, windshield, rear window or rear window flap for a motor vehicle, and can be reliably encapsulated with foam, for example at predetermined positions, by means of the device while an upper side of the respective workpiece is available for further machining steps. For example, by means of folding over and/or moving the folding element or the folding elements in a translatory manner, an edge of a window for a motor vehicle can be encapsulated with foam and simultaneously or swiftly after or before encapsulating with foam add-on elements which are to be attached to an upper side of the respective window can be adhesively bonded.

The described device thereby permits reliable and time-saving machining of windows and workpieces which are plate-shaped in some other way for a motor vehicle and contributes to a cost-effective construction of motor vehicle components.

Owing to the fact that a separate upper tool, such as, for example, a plate provided with recesses and an associated mold carrier, can be omitted, a neat and space-saving tool for machining plate-shaped workpieces can be realized by means of the described device. In comparison to tools which require an upper part, the device also contributes to a saving on material and weight, which, in turn, has an advantageous effect on the costs for the construction of such a device.

The described device without an upper tool can be simplified in respect of its structure and its design and can be configured in a particularly space-saving manner. On account of the saved construction space and the reduced weight that an upper tool including mold carrier and framework would involve, the lower tool is relieved of load and has to be able to hold and move less weight during a machining operation. The described device therefore permits additional simplifications with regard to the activation and mobility of the interacting components. The forces required for moving the lower tool can be correspondingly reduced, and therefore a contribution is made to energy- and cost-efficient machining of a plate-shaped workpiece.

The folding element is configured in such a manner that it is open in the first state and ready for receiving a workpiece to be machined and, in the second, folded-over state and/or state moved in a translatory manner, forms a first predetermined cavity in interaction with the molding body of the lower tool and the clamped workpiece. Such a first cavity can be formed, for example, continuously and can extend in the manner of a hollow frame on and around the edge of the workpiece, or the first cavity forms a plurality of individual cavities spaced apart from one another, and therefore, by means of filling the first cavity with a material provided for this purpose, a continuous, integral frame or a predetermined number of individual, separate plastics moldings can be formed.

The folding element comprises at least one component which can be folded over and/or is movable in a translatory manner in order to form the first cavity. A plurality of components which can be folded over and/or are movable in a translatory manner in order to form further cavities are optionally also present. Furthermore, the device can also have a plurality of mutually separate folding elements, and therefore a folding element is provided, for example, at each lateral edge of a substantially rectangular workpiece, said folding elements, for example in the respective second, folded-over state and/or state moved in a translatory manner, form a type of frame around the workpiece and therefore permit formation of the plastics molding in the form of a continuous border. Directly adjacent folding elements and components are coordinated with one another in a beneficial manner, and therefore reliable forming of a continuous cavity and of an integral plastics molding with a desired contour is possible.

In particular, it is also possible with the described device to form steep contours of the plastics molding, as are optionally desired in the case of outer panels. Contour intervals in the plastics molding can also be formed and can be realized in a simple and reliable manner by means of the folding element and the lower tool of the device. The folding element and the molding body, which interacts therewith, of the lower tool are coordinated with each other in respect of the geometry to be formed of the cavity and consequently also in respect of the geometry to be formed of the plastics molding and make it possible to realize even steep and narrow contours.

According to a development of the device, the lower tool comprises a molding body which has the holding region of the lower tool for the workpiece, and therefore the first cavity can be formed between the holding region of the molding body, the holding region of the folding element and the workpiece. Such a development of the device permits in particular controlled and safe machining of an edge of the workpiece that is reliably surrounded by the molding body and the folding element in the second state.

The description below essentially discusses developments of the device, in which the folding element is pivotable about a first and optionally also further axes, and the first and optionally further cavities is or are formed by means of folding over the folding element and optionally associated components. However, all of the disclosed features and properties are also disclosed for the corresponding elements in the event of a translatory relative movement of the folding element insofar as they do not expressly relate to the capability of the folding element to fold over.

According to a development of the device, the folding element has a first and a second component, wherein the first component is pivotable about the first axis and the second component is pivotable about a second axis. In a folded-over, second state of the first component about the first axis, the first cavity is formed between the mold carrier, the first component and the workpiece. In a folded-over, second state of the second component about the second axis, a second cavity is formed between the first component, the second component and the workpiece.

The two components can be activated independently of each other, and therefore, for example, the workpiece which is to be machined is positioned in a predetermined manner on the molding body of the lower tool and, by means of folding over of the folding element, the first cavity or the first and second cavity is or are formed. The first cavity can be formed, for example, by the first component folding over about the first axis and therefore changing from the first into the second state, and the workpiece subsequently being brought with the molding body in a controlled manner up to the folded-over first component. Alternatively, the workpiece can be positioned with the molding body in a predetermined manner such that the first component subsequently folds over and seals or forms the first cavity. The forming of the second cavity can take place analogously by means of folding over the second component about the second axis and can be carried out independently of the forming of the first cavity.

A first and a second plastics molding can thereby be formed independently of each other by means of introducing predetermined material. For example, the first plastics molding is designed as an outer, encircling foam encapsulation, while the second plastics molding realizes an inner frame. The first and/or second plastics molding is, for example, formed from polyurethane. Alternatively, other thermoplastics or materials which permit forming of the first and/or second plastics molding by being introduced into the respective cavity are also conceivable.

Alternatively or additionally to the second component, the folding element can also comprise a component which is movable relative to the workpiece or the lower tool by means of a translatory movement in order to permit a controlled forming of a further cavity and/or a reliable and safe positioning of add-on elements which are to be adhesively bonded on. For example, the second component is realized as a cylinder element or clamping element which can be moved or actuated in a predetermined manner, for example horizontally and/or vertically, in order to permit forming of the second cavity and/or predetermined positioning of add-on elements on the workpiece.

The first and second axis, about which the respective component can fold over and can change from the first into the second state, are, for example, oriented parallel to a substantial plane of extent of the plate-shaped workpiece. In further embodiments of the device, the axes can also be oriented perpendicular or in some other way to the substantial plane of extent of the plate-shaped workpiece. Furthermore, the first and second axis of a folding element do not inevitably have to be oriented identically, and therefore a different type of axis orientation and therefore folding over of the respective component may be beneficial, depending on the use. In addition, the at least one folding element can also have more than two components, and therefore further cavities can be formed in the described manner.

According to a development of the device, in the region of the first cavity which can be formed, the molding body and/or the folding element each has a predetermined first boundary surface which comprises silicone and/or aluminum and/or steel and/or plastic. Alternatively or additionally, the folding element comprises one or more second boundary surfaces which comprise silicone and/or aluminum and/or steel and form the second cavity in the second state of the second component. The second cavity is formed in particular by the first and second component, and therefore the second boundary surface of the folding element is at least partially formed on a surface of the first component and partially on a surface of the second component.

This permits reliable and safe forming of the first and/or second plastics molding by means of the described device. The boundary surfaces form a predetermined outer shape of the respective cavity and are beneficially adapted to the material to be fed in and the plastics molding to be formed, and therefore the latter, after being formed, can be, for example, released from the folding element and the molding body without residue.

According to a development of the device, the device comprises a first material dispenser which is movable relative to the lower tool and which is designed for introducing a predetermined material into the first and/or second cavity which can be formed, in order to form a first and/or second plastics molding. The described device optionally also permits the forming of further cavities, for example by means of further components of the folding element, which can be filled by means of the material dispenser. Such a material dispenser is realized, for example, in the form of a mixing head which, at predetermined positions, can introduce material into the first and/or second cavity formed and/or into further cavities. The first and/or second plastics molding can therefore be formed within the scope of an injection molding process.

According to a development, the device comprises a second material dispenser which is movable relative to the lower tool and which is designed for dispensing a predetermined material onto the workpiece in order to arrange an add-on element on the workpiece. Such a second material dispenser can realize in particular a mixing head for adhesively bonding add-on elements in order, additionally to the first material dispenser, to permit a further machining step simultaneously or swiftly for forming the plastics molding or the plastics moldings. By means of the second material dispenser, add-on elements can be selectively adhesively bonded on, for example in the inner region of the workpiece.

Alternatively or additionally, the first material dispenser can also be designed for an adhesive bonding process, and therefore, for example, only one material dispenser is required in order to permit foam encapsulating and adhesive bonding and to realize a particularly neat molding tool by means of the described device. For example, the respective material dispenser has various feed lines through which the predetermined materials can be fed and/or applied. Furthermore, the second material dispenser can also be capable of feeding predetermined material for forming the first and/or second plastics molding into the respective cavity or also of producing separate foam encapsulation contours. Furthermore, the device can comprise yet further material dispensers or mixing heads which can contribute to a shorter machining time of the plate-shaped workpiece.

According to a development of the device, the molding body and/or the folding element have a heating element for controlling the temperature of the molding body and/or of the folding element. The device as a molding tool is thereby extended to the effect that the temperature of the molding body and/or of the folding element can be controlled in a predetermined manner, in particular in the region of the first and/or second cavity to be formed. Within the scope of forming the first and/or second plastics molding, the respective components can be heated to a predetermined machining temperature in order to permit reliable and safe forming of the plastics moldings. The heating elements therefore permit, for example, adaptation of the temperature of the respective cavity or of the associated boundary surfaces to a predetermined machining temperature.

A method according to the invention for machining a plate-shaped workpiece for a motor vehicle comprises providing the workpiece and providing a lower tool with a holding region for the workpiece, and providing a folding element which is movable relative to the lower tool. The method furthermore comprises positioning the workpiece and the lower tool with respect to each other and moving the folding element relative to the lower tool in a translatory manner from a first state into a second state and thereby arranging the folding element at and/or on the workpiece. The folding element and the workpiece are arranged with respect to each other and make contact in such a manner that a first cavity is formed between the folding element and the workpiece. The method furthermore comprises introducing a predetermined material into the first cavity and thereby forming a first plastics molding.

A further method according to the invention for machining a plate-shaped workpiece for a motor vehicle comprises providing the workpiece and providing a lower tool with a holding region for the workpiece, and providing a folding element which is pivotable relative to the lower tool about a first axis. The method furthermore comprises positioning the workpiece and the lower tool with respect to each other, and folding over the folding element about the first axis from a first state into a second state and thereby arranging the folding element at and/or on the workpiece. The folding element and the workpiece are arranged with respect to each other and make contact in such a manner that a first cavity is formed between the folding element and the workpiece. The method furthermore comprises introducing a predetermined material into the first cavity and thereby forming a first plastics molding.

Cost-effective and time-saving machining of a plate-shaped workpiece for a motor vehicle is in each case possible by means of the described methods. The method comprises in particular using one of the previously described devices as a special molding tool for machining a respective workpiece, and therefore all of the features and properties of the previously described devices are also disclosed for the corresponding method, and vice versa.

In particular, it is pointed out that such a method for machining a plate-shaped workpiece for a motor vehicle can comprise using one or more folding elements which are designed to be movable in a translatory manner, in particular horizontally, and/or to be pivotable in order to form designated cavities and/or predetermined positions for add-on elements.

In addition, it is pointed out that the previously described devices and the corresponding methods are based on a common inventive concept permitting reliable and time-saving machining of the plate-shaped workpiece. In particular, such efficient machining is made possible by the folding element which is movable in a translatory manner and/or is pivotable.

The further description essentially discusses developments of the method, in which the folding element is pivotable about a first and optionally also further axes, and the first and optionally further cavities are formed by means of folding over the folding element and optionally associated components. However, all of the disclosed features and properties are also disclosed for the corresponding elements for a translatory relative movement of the folding element insofar as they do not expressly relate to the capability of the folding element to fold over.

According to a development of the method, the positioning of the workpiece and of the molding body with respect to each other comprises placing the workpiece on a holding element of the lower tool.

According to a development of the method, the positioning of the workpiece and of the molding body with respect to each other comprises displacing the workpiece relative to the molding body by means of a punch element of the lower tool. Such a punch element is realized, for example, as a cylinder element or lever element in order to permit reliable and safe positioning of the workpiece.

By means of these developments of the method and of the corresponding device, the workpiece which is to be machined can be simply and reliably positioned in a predetermined manner. The workpiece is centered, for example within the device, by means of one or more punch elements in order to realize a desired starting position for machining the workpiece. In particular, it is possible to coordinate the positioning of the plate-shaped workpiece with the folding element or the folding elements in order to form one or more predetermined cavities in the second state of the folding element or of the folding elements.

According to a development of the method, the positioning of the workpiece and of the molding body with respect to each other comprises coupling the workpiece to a carrier element of the lower tool and carrying along the workpiece by means of the coupled carrier element in a normal direction with respect to a substantial plane of extent of the plate-shaped workpiece.

Within the scope of the method, the carrier element of the lower tool of the device permits the workpiece, which is positioned in a predetermined manner, to be guided gently up to the folding element. For example, the at least one folding element has already been folded over into the second state and/or moved in a translatory manner such that guiding up of the workpiece, which is to be machined, by means of the movable carrier element or carrier elements permits the forming of the first and/or second cavity. Alternatively, guiding up can also take place before or simultaneously with the folding over of the folding element, and therefore the positioning of the workpiece and the folding over of the folding element and forming of a respective cavity are always coordinated with one another in terms of time.

According to a development, the method comprises controlling the temperature of the molding body and/or of the folding element. By means of the heating elements, the temperature of the molding body and/or of the folding element can be controlled in a predetermined manner in order, in particular in the region of the respective cavity, to adapt the temperature of the respective boundary surfaces to a predetermined processing temperature.

According to a development of the method, the folding over of the folding element comprises folding over a first component about the first axis and folding over a second component about a second axis. In this manner, in addition to the first cavity, a second cavity can be formed in order to permit the forming of a second plastics molding. For example, it is possible by means of the described method to form the first plastics molding as an outer foam encapsulation and the second plastics molding as an inner foam encapsulation, with respect to an edge of the plate-shaped workpiece. By predetermining the respective cavities, the first and/or the second plastics molding can be designed as a continuous injection molding element or as a plurality of separate injection molding elements.

According to a development, the method comprises providing a frame element and arranging the frame element on the workpiece. The method furthermore comprises folding over the second component about the second axis and thereby forming the second cavity between the first component, the second component, the workpiece and the frame element.

This development of the method realizes a further possibility of forming the second cavity which is formed in conjunction with the frame element. The latter advantageously has boundary surfaces with predetermined contours in order to permit a desired formation of the second plastics molding. After the second cavity is formed, the latter can be filled by means of introducing a predetermined material within the scope of the method for machining the workpiece and can thereby permit the formation of the second plastics molding.

Alternatively or additionally, the second component is movable relative to the workpiece or the lower tool in a translatory manner, for example horizontally and/or vertically, in order to permit controlled forming of the second cavity and/or reliable and safe positioning of add-on elements to be adhesively bonded on. Within the scope of such a machining method, the second component is brought, for example, vertically from above up to the workpiece and in the inner region forms the second cavity and/or a predetermined position for an add-on element to be attached.

According to a development, the method comprises arranging an add-on element on the workpiece by means of an adhesive bonding process. By means of the previously described device, access to the workpiece is possible, which access can be used within the scope of the method in particular in order, alternatively or additionally to a foam encapsulation or injection molding process, also to permit an adhesive bonding process. Such a machining of the plate-shaped workpiece can be carried out without changing the machine, and therefore a particularly time-saving and cost-effective machining process is possible which has an advantageous effect on a design and installation of a vehicle roof for a motor vehicle. By means of the described method and the corresponding device, additional machining steps, in particular changing of the machine, can be saved and, for example, the costly provision of adhesive bonding lines can be omitted.

According to a development, the method comprises opening up the folding element about the first axis or opening up the folding element about the first and second axis such that the workpiece can be removed from the lower tool.

Exemplary embodiments of the invention are explained in more detail below with reference to the schematic drawings, in which:

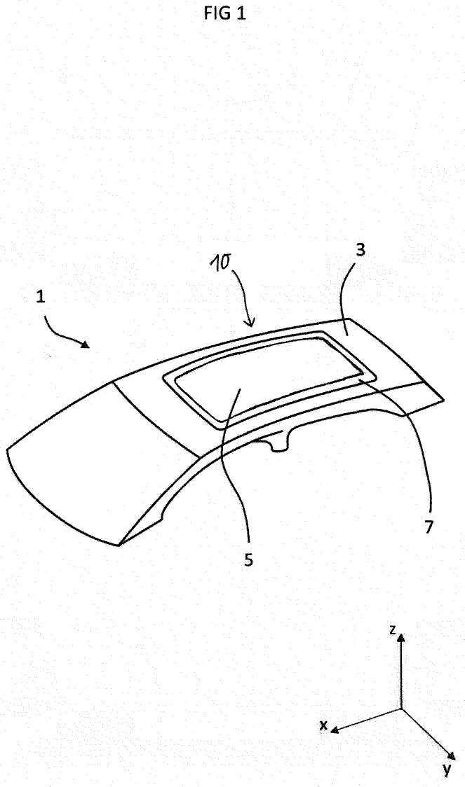

FIG. 1 shows a vehicle roof in a perspective view,

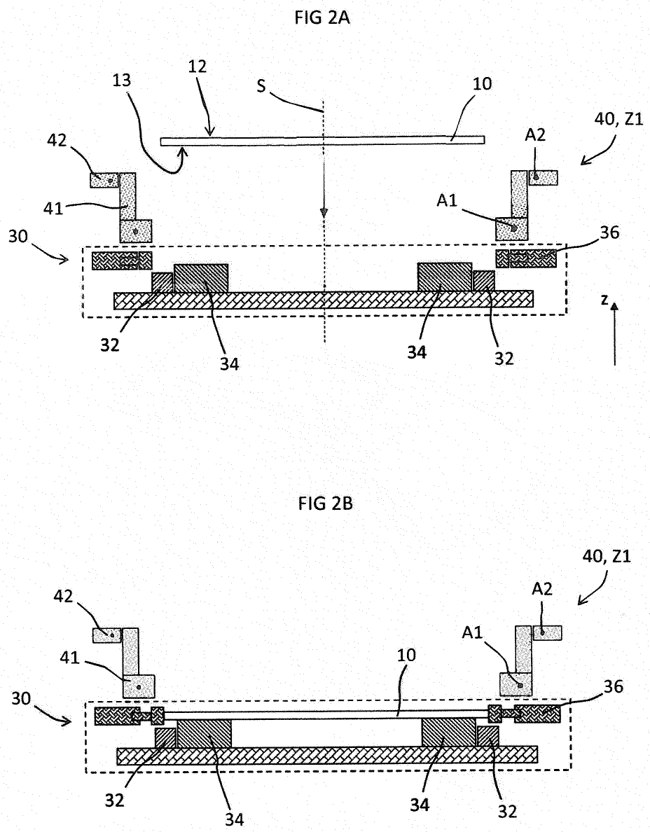

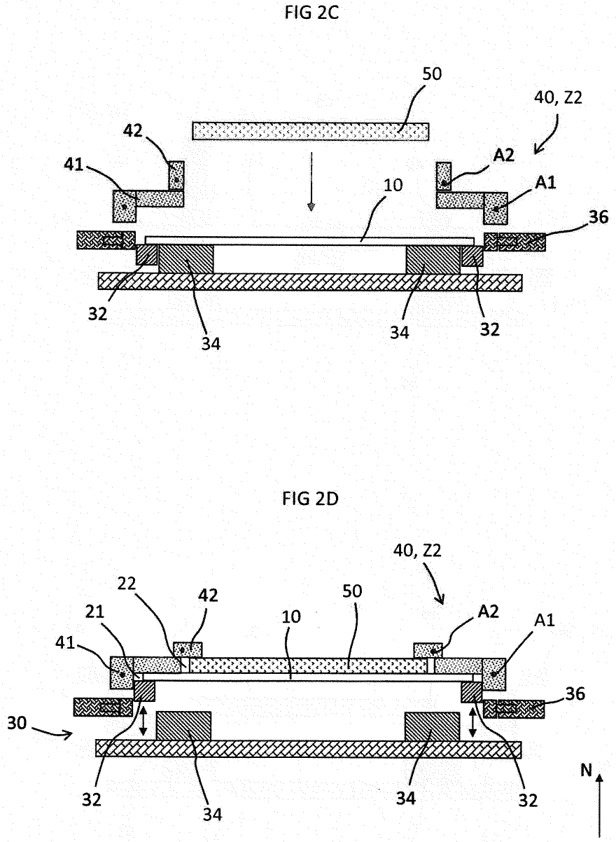

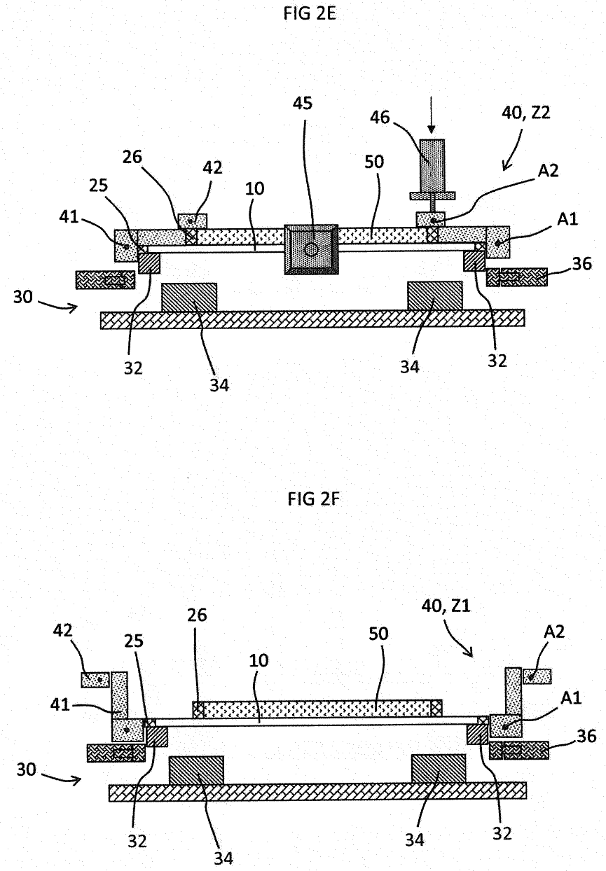

FIGS. 2A-2F show various steps of a method for machining a plate-shaped workpiece for a motor vehicle,

FIGS. 3A-3B show an exemplary embodiment of a device for machining a plate-shaped workpiece for a motor vehicle,

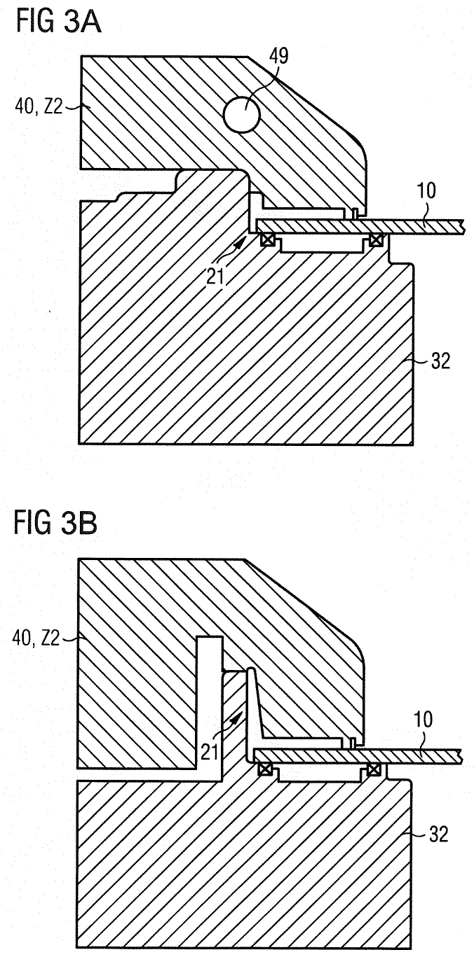

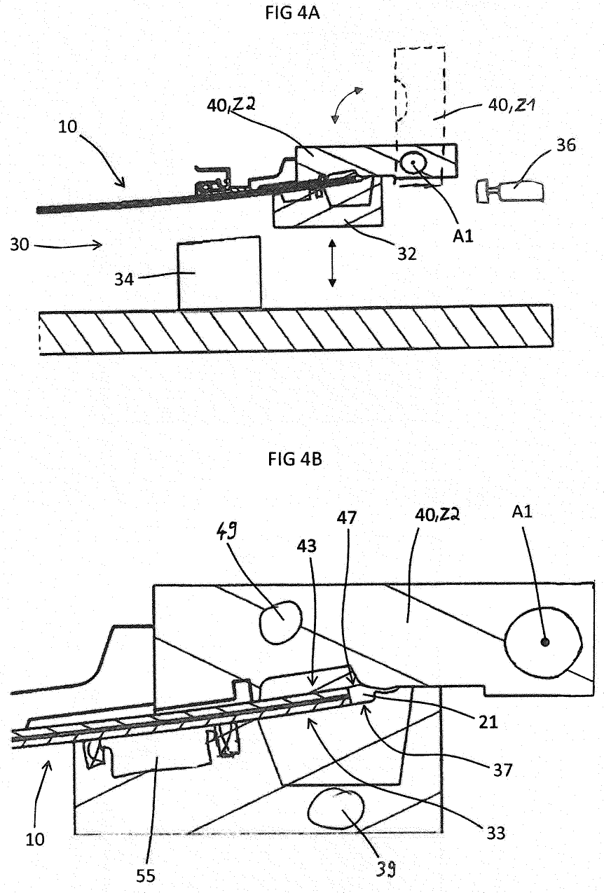

FIGS. 4A-4B show a further exemplary embodiment of the device for machining a plate-shaped workpiece for a motor vehicle,

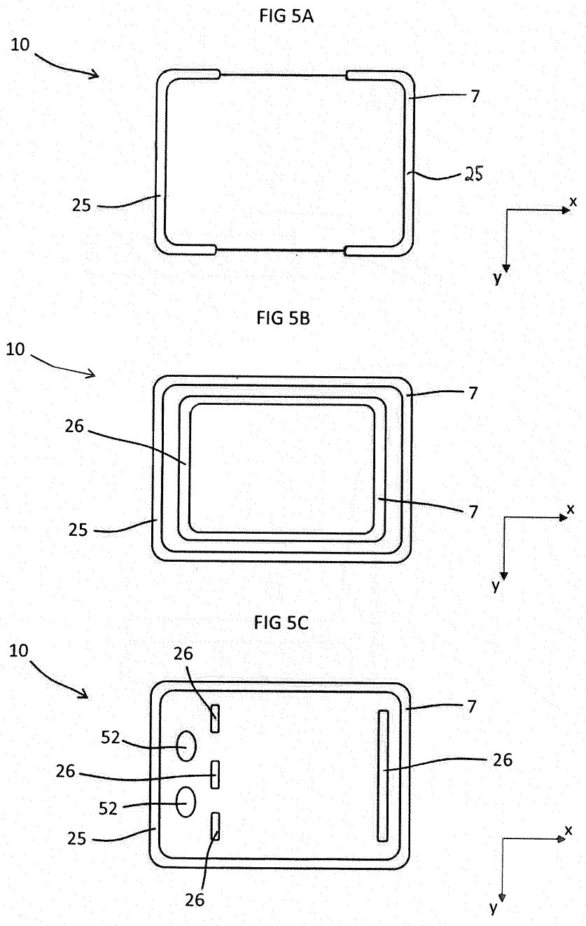

FIGS. 5A-5C show exemplary embodiments of a first and second plastics molding,

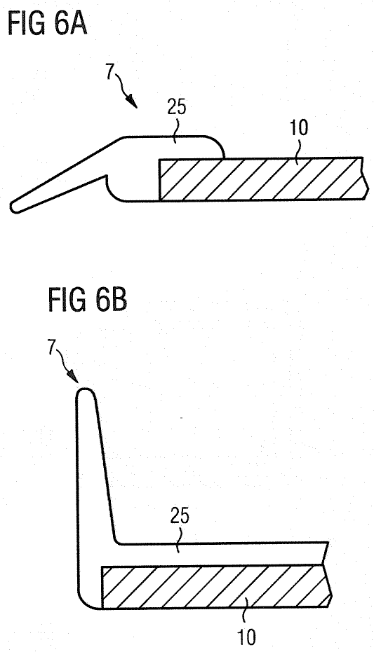

FIGS. 6A-6B show further exemplary embodiments of the first plastics molding.

Elements of identical design or function are identified by the same reference signs throughout the figures. For clarity reasons, not all of the illustrated elements in all of the figures may be identified with reference signs.

FIG. 1 shows schematically, in a perspective view, a motor vehicle 1 with a vehicle roof 3 which has a cover 5 and a foam encapsulation 7. The cover 5 is, for example, a fixed glass element which is immovable with respect to the vehicle roof 3. Alternatively, the cover 5 is movable relative to the vehicle roof 3 in order optionally to open up and to close an opening in the vehicle roof 3.

The foam encapsulation 7 realizes a first plastics molding 25 which can be produced by means of a special device with little outlay and in a time-saving and cost-effective manner within the scope of a method for machining the cover 5. As will be explained with reference to FIGS. 2 to 6 below, the device which is capable thereof realizes a special molding tool and permits advantageous machining of a plate-shaped workpiece 10 for a motor vehicle 1.

FIGS. 2A to 2F show various steps of a method for machining the plate-shaped workpiece 10 in a schematic sectional illustration by means of a configuration of the previously mentioned device. The plate-shaped workpiece 10 can represent, for example, the cover 5 from FIG. 1, which is designed as a glass or plastics cover. In other refinements, the plate-shaped workpiece 10 can be realized by a side window, windshield, rear window, tailgate window or else by a metallic cover, a panel or a plastics part.

FIG. 2A schematically illustrates a first step of a method for machining the plate-shaped workpiece 10. The device has a lower tool 30 and one or more folding elements 40. Four folding elements 40 are beneficially arranged with respect to a lateral edge of a substantially rectangular plate-shaped workpiece 10, in each case one on each side. Opposite folding elements are therefore arranged spaced apart from one another such that free access from above to the workpiece is provided between opposite folding elements. In this connection, it is pointed out that terms such as “top” or “bottom” and “upper tool” or “lower tool” relate to a vertical direction in accordance with the z direction illustrated.

However, the plate-shaped workpiece can also have other, for example round or oval, geometries which can be machined by means of the device. The term “plate-shaped” essentially refers here to a geometry of the workpiece 10, in which two dimensions predominate in relation to the third dimension. With respect to the illustration illustrated in FIG. 2A, the workpiece 10 has a significantly smaller thickness in the z direction than its substantial extent in the x-y plane (for example as in FIG. 1). In addition, the plate-shaped workpiece 10 can have a curvature, in particular with respect to the substantial plane of extent, as is customarily the case for windows for motor vehicles.

The lower tool 30 has a base plate on which a holding element 34 and a molding body 32 are arranged, the latter also acting as a movable carrier element within the scope of the method. The holding element 34 and the molding body 32 are configured, for example, as a continuous frame, and therefore the illustration shown in FIGS. 2A-2F illustrates, for example, a central section. In other refinements of the device, the holding element 34 and/or the molding body 32 can be of multi-part design.

Furthermore, a line of symmetry S which substantially defines a mirror axis is shown in FIG. 2A. The illustrated elements are present on opposite sides of the device with respect to the line of symmetry S. However, for clarity reasons, not all of the elements on both sides of the line of symmetry S are provided with reference signs. In other refinements of the device, a symmetrical construction is not necessarily provided, and therefore the device can be designed in accordance with its use, for example with respect to different geometries of the workpiece to be machined.

The lower tool 30 furthermore has one or more punch elements 36 which permit reliable positioning of the workpiece 10 on the holding element 34. The folding elements 40 each have a first component 41 and a second component 42, wherein the first component 41 is pivotable about a first axis A1 and the second component 42 about a second axis A2. The axes A1 and A2 are oriented substantially parallel to the plane of extent of the plate-shaped workpiece 10.

In the first step illustrated, the folding elements 40 and the respective first and second component 41 and 42 are provided in an open first state Z1 and for receiving the workpiece 10 to be machined. The workpiece 10 is positioned with a lower side 13 on the holding element 34.

FIG. 2B illustrates a further step within the scope of the machining method, in which the workpiece 10 to be machined is positioned in a predetermined manner on the holding element by means of the punch elements 36. For example, the workpiece 10 is centered relative to the molding body 32 and/or to the folding elements 40.

FIG. 2C shows a step of the method, in which the folding elements 40 and the respective first component 41 have changed into a second state Z2. The respective first component 41 is folded over about the associated first axis A1 and thereby permits forming of a first cavity 21. Also illustrated is a frame element or insert 50 which is placed onto an upper side 12 of the workpiece 10 in the inner region. In addition, the molding body 32 has been moved in the vertical direction and couples on the lower side 13 to the workpiece 10.

FIG. 2D illustrates a further step of the method, in which the movable molding element 32 has carried along the workpiece 10 in the vertical direction in accordance with the normal direction N shown and couples to the folding element 40. The first cavity 21 is thereby formed between the first component 41, the workpiece 10 and the molding body 32. Furthermore, the respective second components 42 have also changed into the second state Z2 by being folded over about the associated second axes A2. A respective second cavity 22 has therefore been formed between the respective first and second component 41 and 42 and the frame element 50 and the workpiece 10.

Alternatively or additionally, the first and/or second cavity 21, 22 can also be formed by means of a folding element 40 which is movable in a translatory manner. The folding element or the folding elements 40 is or are moved relative to the lower tool 30 from the first state Z1, in which they are, for example, spaced apart laterally from the workpiece 10, in the direction of the workpiece 10 and change into the second state Z2, in which they form the first and/or second cavity 21, 22. Such a translatory movement of the respective folding element 40 predominantly takes place in a first direction which is parallel to a main plane of extent of the plate-shaped workpiece 10. In the exemplary embodiments illustrated, the first direction corresponds to a direction in the x-y plane perpendicularly to the z direction and to the normal direction N, shown in FIG. 2D, of the workpiece 10.

For example, opposite folding elements 40 are thus moved in a translatory manner toward each other until a respective predetermined position relative to the workpiece 10 or to the lower tool 30 is reached in order, in contact with the workpiece 10 or other interacting elements, to form one or more designated cavities 21, 22 or to define predetermined positions for attaching add-on elements 54.

Reliable and secure contact of the folding elements 40 with the workpiece 10 or other interacting elements is formed, for example, by means of horizontal placing and/or vertical depositing of the respective folding element 40 at or on the corresponding element. A vertical movement relative to the workpiece 10 and the lower tool 30 is significantly less pronounced here than the previously described horizontal movement in the x-y plane.

Furthermore, the second component 42 can also be activatable independently of the first component 41 of the folding element 40 in such a manner that, for example, the first component 41 can be offset into the second state by means of folding over about the first axis A1, and the second component 42 changes into the second state by a translatory movement by means of horizontal and/or vertical movement, in order to permit controlled forming of the second cavity 22 and/or reliable and secure positioning of add-on elements 54 which are to be adhesively bonded on. For example, the second component is realized as a cylinder element or clamping element which can be moved or actuated in a predetermined manner.

FIG. 2E illustrates how the respective first and second cavities 21 and 22 are filled by means of a first and a second material dispenser 45 and 46, wherein the material dispenser 45 is illustrated with regard to the sectional illustration shown as an element which is placed on. The material dispensers 45, 46 are designed to be movable relative to the clamped workpiece 10 and can feed a material into the cavities 21 and 22 at predetermined positions. This makes it possible to form a first and a second plastics molding 25 and 26, the outer shape of which is predetermined by the delimiting geometry of the first and second cavity 21 and 22. In further refinements of the device, there can also be just one material dispenser which fills the respective cavities 21 and 22 with predetermined material successively or simultaneously, for example by means of various feed lines. Alternatively, there are further material dispensers in order to accelerate the feeding of material into the cavities 21 and 22 which are formed and in order to contribute to a prompt manufacturing process. The material dispensers 45 and 46 are, for example as mixing heads, provided with diverse feed lines.

Alternatively or additionally, the first and/or second material dispenser 45, 46 can also be capable of carrying out an adhesive bonding process in order, for example, in the inner region of the frame element 50, to arrange one or more add-on elements 52 on the upper side 12 of the workpiece 10. This makes it possible to carry out foam encapsulating and adhesive bonding by means of one and the same device without requiring time-consuming changes of the machine. Such an adhesive bonding of add-on elements 52 can be carried out as a further machining step simultaneously or promptly in order to form the first and/or second plastics molding 25 and 26.

In a further step of the method according to FIG. 2F, the folding elements 40 are opened again by the respective first and second component 41 and 42 folding over again about the respective axis A1 and A2 into the first state Z1. The machined workpiece 10 can then be safely removed from the device.

The described device and the corresponding method for machining the plate-shaped workpiece 10 realize an upwardly open tool concept without an upper tool, said tool concept having a movable substructure and one or more folding elements 40. Owing to such a special molding tool, the machining of workpieces 10 is substantially independent of the component size of the workpiece and is therefore not limited to maximum geometries of, for example, 1200 mm times 900 mm, as is customarily the case in the case of molding tools which have solid plates as the upper tool and lower tool and associated mold carriers and form closed cavities without further access to the workpiece.

Owing to the fact that a separate upper tool is not present, a neat and space-saving molding tool for machining plate-shaped workpieces 10 can be realized by means of the device described. The device described therefore includes a significant saving on material and weight in comparison to tools which have an upper tool. This additionally has an advantageous effect on the costs for the design of such a device and leads to further possible savings.

On account of the saved weight that an upper tool including mold carrier would entail, the lower tool 30 is relieved of load and has to be able to hold and move less weight during a machining operation. Such a saving on weight can comprise, for example, several thousand kilograms. The device described therefore permits additional simplifications with regard to activation and mobility of the substructure, and therefore the forces required for moving the lower tool 30 can be correspondingly reduced and a contribution is made to energy- and cost-efficient machining of the plate-shaped workpiece 10.

FIGS. 3A and 3B illustrate further exemplary embodiments of such a device for machining a plate-shaped workpiece 10 in a schematic side view. A folding element 40 is in each case illustrated in the second folded-over state Z2, and therefore the first cavity 21 is formed between the workpiece 10, the folding element 40 and the lower tool 30. In the exemplary embodiment shown, the first cavity 21 is formed between the workpiece 10, the folding element 40 and the mold carrier 32 of the lower tool 30. It is apparent with reference to FIGS. 3A and 3B that, by means of the device described and a corresponding machining method, forming of plastics moldings 25, 26 having steep contours, which, for example, can realize outer panels, is also possible.

FIGS. 4A and 4B show a further exemplary embodiment of the device for machining the plate-shaped workpiece 10. FIG. 4A illustrates the folding element 40 in the open first state Z1 (illustrated by dashed lines) and in the closed second state Z2 (illustrated by solid lines), in which said folding element is folded over about the first axis A1 and, in interaction with the workpiece 10 and the molding body 32, forms the first cavity 21.

FIG. 4B illustrates a detailed view of the exemplary embodiment illustrated according to FIG. 4A, in which a possible geometry of the first cavity 21 can be seen more clearly. Said cavity has a narrow lip or nose which extends away from the workpiece 10. The first cavity 21 is bounded by respective first boundary surfaces 37 and 47 of the molding body 32 and of the folding element 40, which comprise, for example, silicone, aluminum, steel and/or plastic, in order to permit careful, safe and reliable forming of the first plastics molding 25. In a corresponding manner, the outer shape of the first plastics molding 25 to be formed is determined by the contours of the boundary surfaces 37 and 47. The previously described second cavity 22 can be correspondingly bounded by second boundary surfaces which are formed on the folding element 40 or on the first and second component 41 and 42 and the frame element 50.

In this exemplary embodiment, the workpiece 10 is realized as a composite disk which has an outer layer, an inner layer and optionally one or more intermediate layers. In addition, heating elements 39 and 49 are illustrated, said heating elements being arranged within the molding body 32 or within the folding element 40 in order to control the temperature of the respective components in a predetermined manner. This makes it possible for the molding body and/or the folding element to be heated, for example, to a predetermined machining temperature, in particular in the region of the first and/or second cavity 21, 22 to be formed.

Furthermore, the molding body 32 and the folding element 40 respectively have a holding region 33 and 43 made of silicone, aluminum, steel and/or plastic for the workpiece 10, said holding regions permitting safe and reliable holding of the workpiece 10 to be machined. In addition, a vacuum region 55 is formed on the lower side 13 between the workpiece 10 and the molding body 32 and contributes further to reliable holding and stable positioning of the workpiece 10. Furthermore, the device can also comprise yet further holding elements, such as integrated magnets, which contribute to safe and stable holding of the workpiece 10 within the device.

FIGS. 5A to 5C illustrate possible refinements of the first and/or second plastics molding 25, 26. In FIG. 5A, the first plastics molding 25 is realized as a two-part foam encapsulation 7 which surrounds a front and a rear edge of the workpiece 10. In FIG. 5B, the workpiece 10 is machined in such a manner that, by means of the first cavity 21 and the second cavity 22, the first plastics molding 25 is designed as an outer peripheral frame and the second plastics molding 26 is designed spaced apart as an inner peripheral frame. The two plastics moldings 25 and 26 can be produced, for example, within the scope of a foam encapsulation process and can realize a foam encapsulation 7 which is formed from polyurethane in order to permit reliable connection to a body of the motor vehicle 1.

In FIG. 5C, the second plastics molding 26 is formed in multiple parts in the inner region of the workpiece 10. Furthermore, two add-on elements 52 are illustrated which have been attached to the upper side 12 of the workpiece 10 by means of an adhesive bonding process. Such add-on elements can realize, for example, fastening and/or reinforcing elements which contribute to improved stability and simple further processing of the workpiece 10. For example, by means of such elements, the stability of the cover 5 can be increased and simple and reliable connection of the cover 5 to a body of the motor vehicle 1 can be provided.

FIGS. 6A and 6B show two further possible refinements of the first plastics molding 25 which can be formed, for example within the first cavity 21, by means of the device described and a corresponding production method. Owing to the interaction of the folding element 40 and of the molding body 32, relatively steep and narrow outer contours of the plastics moldings 25, 26 can also be produced.

### LIST OF REFERENCE SIGNS

1 Motor vehicle
3 Vehicle roof
5 Cover
7 Foam encapsulation
10 Workpiece
12 Upper side of the workpiece
13 Lower side of the workpiece
21 First cavity
22 Second cavity
25 First plastics molding
26 Second plastics molding
30 Lower tool
32 Molding body
33 Holding region of the molding body
34 Holding element
36 Punch element
37 First boundary surface of the molding body
39 Heating element of the molding body
40 Folding element
41 First component of the folding element
42 Second component of the folding element
43 Holding region of the folding element
45 First material dispenser
46 Second material dispenser
47 First boundary surface of the folding element
49 Heating element of the folding element
50 Frame element
52 Add-on element
55 Vacuum
A1 First axis
A2 Second axis
N Normal direction
Z1 First open state of the folding element or of the respective component
Z2 Second closed state of the folding element or of the respective component

1. A device for machining a plate-shaped workpiece for a motor vehicle, comprising:
a lower tool with a holding region for the workpiece, and a folding element which has a holding region for the workpiece and which is movable in a translatory manner relative to the lower tool in order to change from a first state into a second state by a translatory movement and to form a first cavity between the holding region of the folding element and the workpiece, wherein the translatory movement of the folding element predominantly takes place in a first direction which is parallel to a main plane of extent of the plate-shaped workpiece.

2. A device for machining a plate-shaped workpiece for a motor vehicle, comprising:
a lower tool with a holding region for the workpiece, and
a folding element which has a holding region for the workpiece and which is pivotable relative to the lower tool about a first axis in order to change from a first state into a second state by a device to fold over and to form a first cavity between the holding region of the folding element and the workpiece.

3. The device according to claim 1, in which
the lower tool has a molding body with a holding region for the workpiece, and
the first cavity can be formed between the holding region of the molding body, the holding region of the folding element and the workpiece.

4. The device according to claim 2, in which the folding element has a first component and a second component, wherein the first component is pivotable about the first axis and the second component is pivotable about a second axis in order, in a folded-over second state of the first component about the first axis, to form the first cavity, and, in a folded-over second state of the second component about the second axis, to form a second cavity, between the first component, the second component and the workpiece.

5. The device according claim 1, in which, in the region of the first cavity which can be formed, the lower tool and the folding element each comprise a predetermined first boundary surface which comprises silicone, aluminum, steel and/or plastic.

6. The device according to claim 4, in which, in the region of the second cavity which can be formed, the folding element comprises a predetermined second boundary surface which comprises silicone, aluminum, steel and/or plastic.

7. The device according to claim 1, comprising a first material dispenser which is movable relative to the lower tool and which is designed for introducing a predetermined material into the first and/or second cavity which can be formed, in order to form a first and/or second plastics molding.

8. The device according to claim 1, comprising a second material dispenser which is movable relative to the lower tool and which is designed for dispensing a predetermined material onto the workpiece in order to arrange an add-on element on the workpiece.

9. The device according to claim 1, in which the lower tool have/has a heating element for controlling the temperature of the lower tool and/or of the folding element.

10. The device according to claim 2, in which the folding element is movable in a translatory manner relative to the lower tool in order to change from the first state into the second state by a relative movement and to form the first cavity between the holding region of the folding element and the workpiece, wherein the relative movement of the folding element comprises a translatory movement and folding over about the first axis.

11. A method for machining a plate-shaped workpiece for a motor vehicle, comprising:
providing the workpiece,
providing a lower tool,
providing a folding element which is movable relative to the lower tool
positioning the workpiece and the lower tool with respect to each other,
moving the folding element in a translatory manner from a first state into a second state predominantly along a first direction which is parallel to a main direction of extent of the plate-shaped workpiece and thereby arranging the folding element and the lower tool relative to each other such that the folding element makes contact with the workpiece and a first cavity is formed between the folding element and the workpiece, and
introducing a predetermined material into the first cavity and thereby forming a first plastics molding.

12. A method for machining a plate-shaped workpiece for a motor vehicle, comprising:
providing the workpiece,
providing a lower tool,
providing a folding element which is pivotable relative to the lower tool about a first axis,
positioning the workpiece and the lower tool with respect to each other,
folding over the folding element about the first axis from a first state into a second state and thereby arranging the folding element and the lower tool relative to each other such that the folding element makes contact with the workpiece and a first cavity is formed between the folding element and the workpiece, and
introducing a predetermined material into the first cavity and thereby forming a first plastics molding.

13. The method according to claim 11, in which the lower tool has a molding body with a holding region for the workpiece, comprising:
positioning the workpiece and the molding body with respect to each other, and
forming the first cavity between the holding region of the molding body, the holding region of the folding element and the workpiece.

14. The method according to claim 11, in which the lower tool has a holding element, and the positioning of the workpiece and the lower tool with respect to each other comprises:
placing the workpiece onto the holding element.

15. The method according to claim 11, in which the lower tool has a punch element, and the positioning of the workpiece and the lower tool with respect to each other comprises:
displacing the workpiece relative to the lower tool by the punch element.

16. The method according to claim 11, in which the lower tool is movable relative to the folding element, and the positioning of the workpiece and the lower tool with respect to each other comprises:
coupling the workpiece to the lower tool, and
carrying along the workpiece by the lower tool along a normal direction with respect to a main plane of extent of the plate-shaped workpiece.

17. The method according to claim 11, comprising:
controlling the temperature of the lower tool and/or of the folding element.

18. The method according to claim 12, in which the folding element has a first component and a second component, wherein the first component is pivotable about the first axis and the second component is pivotable about a second axis, and therefore the folding over of the folding element comprises:
folding over the first component about the first axis and thereby forming the first cavity between the first component, the molding body and the workpiece, and
folding over the second component about the second axis and thereby forming a second cavity between the first component, the second component and the workpiece.

19. The method according to claim 18, comprising:
providing a frame element,
arranging the frame element on the workpiece, and
folding over the second component about the second axis and thereby forming the second cavity between the first component, the second component, the workpiece and the frame element.

20. The method according to claim 18, comprising:
introducing a predetermined material into the second cavity and thereby forming a second plastics molding.

21. The method according to claim 11, in which the introducing of material into the first and/or second cavity comprises:
forming the first and/or second plastics molding in the form of an encircling foam encapsulation.

22. The method according to claim 11, comprising:
arranging an add-on element on the workpiece by an adhesive bonding process.

23. The method according to claim 12, comprising:
opening up the folding element about the first axis or about the first axis and second axis such that the workpiece can be removed from the lower tool.

24. The method according to claim 12, in which the folding element is movable in a translatory manner relative to the lower tool, and the arranging of the folding element and the lower tool relative to each other comprises:
moving the folding element relative to the plate-shaped workpiece from the first state into the second state such that the folding element makes contact with the workpiece and the first cavity is formed between the folding element and the workpiece, wherein the relative movement of the folding element comprises folding over about the first axis and a translatory movement along a first direction which is parallel to a main plane of extent of the workpiece.
